(19) United States
(12) Patent Application Publication
(10) Pub. No.: US 2008/0056787 A1
(43) Pub. Date: Mar. 6, 2008

(54) PRINTING WITH TWO-SIDE PRINTABLE AND ONE-PASS PRINTABLE SHEETS

(76) Inventors: Jan Dirk Boness, Bad Bramstedt (DE); Stefan Schrader, Kiel (DE)

Correspondence Address: David A. Novais, Patent Legal Staff;Eastman Kodak Company, 343 State Street, Rochester, NY, 14650-2201, US

(21) Appl. No.: 11/847,452

(22) Filed: Aug. 30, 2007

(30) Foreign Application Priority Data
Aug. 30, 2006 (DE) 102006040527.7

(51) Int. Cl. G03G 15/00

(52) U.S. Cl. 399/364

(57) ABSTRACT

In the system and method, a conveyor having a sequence of sheet supports is moved through a printer. During a first pass: two-side printable sheets are placed into sheet supports of a first segment of the sequence; one-pass printable sheets are excluded from a skipped second segment of sheet supports, and the two-side printable sheets are verso-printed. The printed sheets are then flipped. During a second pass: the two-side printable sheets are recto-printed; one-pass printable sheets are introduced into the second segment and are recto-printed. The printed sheets are delivered to an output holder in order. The one-pass printable sheets have a printable recto side and a ventro side that is a vector of contamination to the printer, at least when printed second.

This application claims priority from German Patent Application No. 102006040527.7 filed on Aug. 30, 2006.

### FIELD OF THE INVENTION

The invention relates to printing apparatus and methods and more particularly relates to printing with two-side printable and one-pass printable sheets.

### BACKGROUND OF THE INVENTION

Most types of print media sheets can be printed sequentially on one side and then the other; however, there are some types of print media for which two-sided printing, at least by some methods, is highly problematic. For example, attempting to print both sides of an adhesive label can release adhesive, lastingly contaminating a printing apparatus, and significantly impairing subsequent printing. Plastic films are similarly problematic for two-sided, toner-based (electrostatographic) printing. For example, in an electrophotographic press, after one side of a plastic film has been printed, the plastic film carries fuser oil, which can be transferred to surfaces in the press as a contaminant. Such contamination of a transport belt or the like would significantly impair subsequent printing operations. For convenience, the term “one-pass printable sheet” is used herein to refer to such problematic print media that are vectors of contamination if used for such two-pass printing. The term “two-side printable sheet” is used herein to refer to other types of print media. It should be noted that the term “two-side printable sheet” is inclusive of both sheets that provide good copy when printed on both sides and sheets that although two-side and two-side printable without deleterious affect on a printer, do not necessarily provide good copy on one side.

Digital presses provide variable data printing, which allows copies of multiple sheet print jobs to be printed in final order without a separate collating procedure. Much of the benefit of this approach is lost; however, if an unsuitable sheet is part of the print job, as a cover sheet or pull-out or the like. If all of the other sheets of a print job are two-side printable, it would not be very economical for a special sheet to be printed separately from the print job and collated after printing.

It would therefore be desirable to provide printing systems and methods, in which one-pass printable sheets and two-side printable sheets can be easily and conveniently printed using variable data printing.

### SUMMARY OF THE INVENTION

The invention is defined by the claims. The invention, in broader aspects, provides a system and method, in which a conveyor having a sequence of sheet supports is moved through a printer. During a first pass: two-side printable sheets are placed into sheet supports of a first segment of the sequence; one-pass printable sheets are excluded from a skipped second segment of sheet supports, and the two-side printable sheets are verso-printed. The printed sheets are then flipped. During a second pass: the two-side printable sheets are recto-printed; one-pass printable sheets are introduced into the second segment and are recto-printed. The printed sheets are delivered to an output holder in order. The one-pass printable sheets have a printable recto side and a ventro side that is a vector of contamination to the printer, at least when printed second.

It is an advantageous effect of the invention that printing systems and methods are provided, in which one-pass printable sheets and two-side printable sheets can be easily and conveniently printed using variable data printing.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIGS. 1a-1d are diagrammatical views of an embodiment of the system at successive stages in performing an embodiment of the method. The sequence of sheet supports used corresponds to the numbers on the sheets in FIGS. 1a-1d. The letters indicate the side facing the print engine or engines: “V” for verso and “R” for recto. The first segment is numbered 1-11. The second segment is numbered 12. The third segment is numbered 13-14.

FIG. 2a is a partial diagrammatical view of the conveyor of the apparatus of FIGS. 1a-1d following recto-printing. Three sheet supports are shown (numbers 11-13 in FIGS. 1a-1d).

FIG. 2b is the same view as FIG. 2a, but follows verso-printing.

### DETAILED DESCRIPTION OF THE INVENTION

In the method and system, print media sheets are continuously printed in a sequential order that is maintained in the finished print product. The printing is accomplished with one recto-printing pass and one verso-printing pass through the printing apparatus. Two-side printable sheets are subject to both recto- and verso-printing. One-pass printable sheets are introduced at an appropriate place in the sequential order and are printed on only one side.

The terms “recto-printing” and “verso-printing” and like terms are used herein to refer to the printing of opposite sides of the print media sheets. The term “recto” is used to refer to the front side of a sheet and the term “verso” to the reverse side of the sheet, during printing. It will be understood that, in some cases, either side of a media sheet can be the front or recto side, while in other cases the front is defined by a difference in the two sides. It will also be understood that the front and back may be interchanged by later finishing operations and to that extent, the terms “recto” and “ventro” are arbitrary.

The order of the sheets during printing matches the sequential order of the sheets in the printed output, both before and after finishing. For example, a print job has a stack of two-side printable sheets topped by a one-pass printable cover. The last two-side printable sheet of the print job can be printed first and the first two-side printable sheet can be printed last each time, during recto- and verso-printing passes through a press. The cover sheet is then introduced and printed at the end of the verso-printing pass. The two-side printable sheet could be DIN A4 size and the one-pass printable sheet could be an outer cover of DIN A3 size, with the cover being folded over the other sheets during finishing following verso-printing.

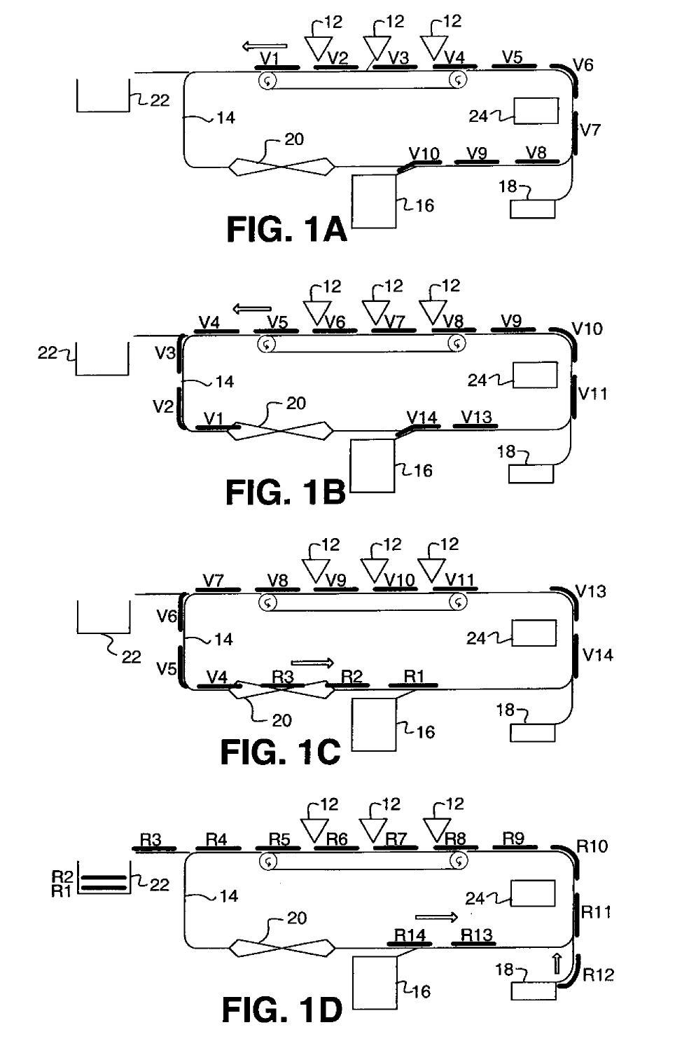

Referring now to FIGS. 1a-1d, in a particular embodiment, the printing system includes one or more print engines and data input units (symbolized collectively in FIGS. 1a-1d by a pattern of three triangles 12), a conveyor 14, first and second sheet supply units 16 and 18, an inverter 20, an output holder and finishing equipment (symbolized collectively in FIGS. 1a-1d as a U-shaped bin 22) and a control unit 24.

The type and number of print engines is not critical. For example, a single page-width ink jet printhead could be used. The system is particularly advantageous for electrophotographic print engines, since the contamination risk presented by plastic sheets with such print engines is commonly encountered. The locations of the print engines along the transport path are not critical, except that two passes, that is, circuits, of a sheet along the transport path are required to print both sides of the sheet. It is currently preferred that the same one or more print engines are used to print both sides of the sheet. The data input units supply digital images suitable for printing to the one or more print engines.

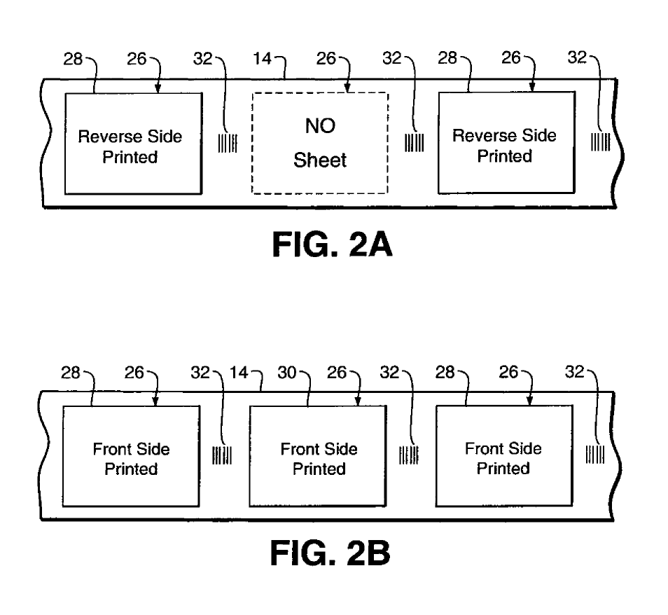

The conveyor has a sequence of sheet supports 26 (indicated by reference arrows 26 and in FIG. 2a by the dashed line box). The number of sheet supports is a function of the length of the conveyor and is not critical. Each sheet support can hold a single print media sheet (a two-side printable sheet 28 or a one-pass printable sheet 30) for transport through the printing apparatus along a transport path that extends past the print engines. The conveyor is continuously operated during printing.

A sheet support can be a physical subdivision of the conveyor or can be a virtual subdivision of a continuous conveyor having dimensions sufficient to receive a respective printable sheet. In a particular embodiment, the conveyor is an endless belt and the sheet supports are arranged in a continuous sequence in which gaps between adjoining sheet supports are absent or insufficiently small to receive a media sheet.

Referring to FIGS. 2a-2b, the locations of virtual sheet supports can be designated by markings 32 readable by a sensor (not separately illustrated) directed toward the transport path of the conveyor. The manner of operation of the sensor is not critical. For example, the sensor can be optical or infrared. Virtual sheet supports can also be defined by travel or position of the conveyor relative to print engines or another part of the press. For example, a roll or belt that drives the conveyor can include an optical encoder that is used to determine travel. In a particular embodiment, the conveyor is a transparent endless belt having indicia, which indicate the locations of each of the sheet supports. The indicia are read by a sensor, which is mounted to the body (not separately illustrated) of the printing apparatus in operative relation to the conveyor. The indicia can be bar codes that identify the respective sheet supports.

Sheet supports can either be limited to sheets of a specific size or can receive sheets in a variety of sizes. The latter allows flexibility in selection of media sheets, including mixing sheets of different sizes in the same print job. With virtual sheet supports, the dimensions of the sheet supports can be fixed, that is, unchanging, or can be variable to meet the requirements of different size sheets.

The sheet supply units deliver sheets one-by-one to the sheet supports. In the illustrated embodiment, there are first and second sheet supply units. Other numbers of supply units could be provided. Equipment and methods for supplying sheets are well known to those of skill in the art.

An inverter flips the transported sheets over and returns them to respective sheet supports. Inverters are well known to those of skill in the art.

The output holder and finishing equipment can be limited to a simple bin or the like or can provide any of the various features known to those of skill in the art. Once fully printed, the sheets are delivered to and collected in the output holder and, optionally, are then finished in the finishing equipment. Finishing can include one or more of: binding, punching, and stapling. Equipment and methods for these purposes are well known to those of skill in the art.

The control unit operates the other components of the system utilizing stored software and data based upon signals from input devices (not shown). Appropriate sensors are utilized to provide control signals for the apparatus. Some operations of the control unit are discussed below in relation to the method. The control unit can include, but is not limited to, a programmable digital computer, a programmable microprocessor, a programmable logic processor, a series of electronic circuits, a series of electronic circuits reduced to the form of an integrated circuit, or a series of discrete components. Necessary programs can be provided on fixed or removable memory or the control processor can be programmed, as is well known in the art, for storing the required software programs internally. Different numbers of the processors can be provided, as appropriate or convenient to meet particular requirements, or a single processor can be used. Parameters for the processors are supplied from memory. “Memory” refers to one or more suitably sized logical units of physical memory provided in semiconductor memory or magnetic memory, or the like. Memory can include conventional memory devices including solid state, magnetic, optical or other data storage devices and can be fixed within system or can be removable. Data including but not limited to control programs can also be stored in a remote memory system such as a personal computer, computer network or other digital system. In addition to functions necessary to operate the system, other functions can be provided, such as image rendering, enhancement, and restoration, manual editing and intervention in automated (machine-controlled) operations. Those skilled in the art will recognize that the equivalent of software can also be readily constructed in hardware. Because image manipulation algorithms and systems are well known, the present description emphasizes algorithms and features forming part of, or cooperating more directly with, the method and system. General features of the types of computerized systems discussed herein are well known, and the present description is generally limited to those aspects directly related to the invention. Other aspects of such algorithms and apparatus, and hardware and/or software for producing and otherwise processing the image signals involved therewith, not specifically shown or described herein may be selected from such systems, algorithms, components, and elements known in the art. Given the description as set forth herein, all additional software/hardware implementation is conventional and within the ordinary skill in the art. The system can be implemented in a combination of software and/or hardware and is not limited to devices, which are physically connected and/or located within the same physical location. One or more of the components can be located remotely and can be connected via a network.

In a particular embodiment, the printing system includes a color electrophotographic printer (not shown). In this case, color separation images are formed and transferred in register by four color toner units to each sheet supported on the conveyor. The toner units can be configured to be mechanically operated by the conveyor, which operates continuously during printing. The conveyor is an endless belt having a top layer of a material having a bulk electrical resistivity. The belt material can be of any of a variety of flexible materials such as a fluorinated copolymer (such as polyvinylidene fluoride), polycarbonate, polyurethane, polyethylene terephthalate, polyimides (such as Kapton®), polyethylene napthoate, or silicone rubber. An additive can be used, such as an anti-stat (e.g. metal salts) or small conductive particles (e.g. carbon), to impart the desired resistivity. When materials with high resistivity are used, additional corona charger(s) may be needed to discharge any residual charge remaining on the web once the substrate has been removed. The belt can have a conducting layer beneath the resistive layer, which is electrically biased to urge toner image transfer. The conducting layer can be the support layer or an additional layer. Alternatively, the conducting layer is absent and the transfer bias is applied through either one or more of the support rollers or with a corona charger.

In feeding sheets from the sheet supplies into the sheet supports, charge can be provided on the sheets by a charger to electrostatically attract the sheets and “tack” them to the conveyor. A blade associated can be provided to press the sheets onto the belt and remove entrained air. The color toner units each transfer a respective toner from a toner supply to a photoconductor, which is charged responsive to image information. The resulting toner image is then transferred, either directly or indirectly, to the sheet in the sheet supply. After toning, the sheets are detacked from the sheet supports and sent to a fusing station to fuse the dry toner images to the sheets. A detack charger can deposit a neutralizing charge on the sheets to facilitate separation from the sheet supports. The sheets are then delivered to the output unit.

Referring again to FIGS. 1a-1d, in a particular embodiment of the method, the sequence of sheet supports is moved in two passes through the printer to print the pages of a copy of the print job. During the first pass, each of a plurality of two-side printable sheets are placed into respective sheet supports of a first segment of the sequence. One-pass printable sheets that are to be printed are excluded from the sheet supports during the first pass. While the one-pass printable sheets are excluded, the conveyor continues to move. This results in a second segment of one or more sheet supports (one is shown in FIGS. 1a-1d) that are skipped and empty of any sheets. The second segment of skipped sheet supports remains open until the second pass. An additional one or more of the two-side printable sheets are placed into respective sheet supports of a third segment of the conveyor. In the sequence of sheet supports, the third segment follows the second segment, which follows the first segment.

The two-side printable sheets in the second and third segments then move to the print engine or engines and are verso-printed. After verso-printing, the two-side printable sheets move to the inverter and are flipped over and replaced in respective sheet supports. The sequence of sheet supports is then moved in a second pass through the printer. During the second pass, the two-side printable sheets in the first segment are recto-printed. One-pass printable sheets are then introduced into respective sheet supports of the second segment. The one-pass printable sheets in the second segment and the two-side printable sheets in the third segment are then recto-printed. This completes the printing. The printed sheets are then delivered to an output holder in the order of the sheet supports, which corresponds to the order, in which the sheets were recto-printed. The sheets can then be finished. The order is maintained during finishing. In a particular embodiment, the printed sheets are collected in a single stack following the recto-printing steps. The stack has the sheets in front-to-back order, which is maintained during finishing.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like is not limiting.

The invention has been described in detail with particular reference to certain preferred embodiments thereof, but it will be understood that variations and modifications can be effected within the spirit and scope of the invention.

1. A printing method for use with a printer having a conveyor having a sequence of sheet supports, said method comprising the steps of:
moving said sequence of sheet supports in a first pass through said printer;
placing each of a plurality of two-side printable sheets into respective sheet supports of a first segment of said sequence during said moving of said sequence in said first pass, said two-side printable sheets each having two opposed, sequentially-printable sides;
excluding one or more one-pass printable sheets from said sequence of sheet supports during said moving of said sequence in said first pass, said one-pass printable sheets each having a printable recto side and a ventro side that is a vector of contamination to the printer, at least when printed sequential to said recto side, said excluding defining a skipped, second segment of said sequence, said second segment having one or more sheet supports;
verso-printing said two-side printable sheets during said moving of said sequence in said first pass;
flipping over and replacing each of said plurality of two-side printable sheets in a respective said sheet support of said first segment;
moving said sequence of sheet supports in a second pass through said printer;
recto-printing said two-side printable sheets during said moving of said sequence in said second pass;
introducing said one-pass printable sheets into respective said sheet supports of said second segment during said moving of said sequence in said second pass;
recto-printing said one-side printable sheets during said moving of said sequence in said second pass; and
then, delivering said sheets to an output holder in an order defined by said recto-printing steps.

2. The method of claim 1 further comprising, following said delivering:
finishing said sheets; and
during said finishing, maintaining said sheets in said order defined by said recto-printing steps.

3. The method of claim 2 wherein said one or more one-pass printable sheet is an outer cover.

4. The method of claim 1 wherein said printer is a digital electrophotographic printer, said one-pass printable sheets are plastic sheets, and said contamination is fuser oil.

5. The method of claim 1 wherein said one-pass printable sheets are adhesive labels and said contamination is adhesive.

6. The method of claim 1 wherein said second segment follows said first segment.

7. The method of claim 6 further comprising the steps of:
following said excluding, placing an additional one or more of the two-side printable sheets into respective sheet supports of a third segment of said conveyor during said moving of said sequence in said first pass, said third segment following said second segment;
verso-printing said additional two-side printable sheets during said moving of said sequence in said first pass;
flipping over and returning said additional two-side printable sheets into respective said sheet supports of said third segment; and
recto-printing said additional two-side printable sheets during said moving of said sequence in said second pass;
wherein said verso-printing and flipping over of said additional two-side printable sheets precede said introducing and said recto-printing of said additional two-side printable sheets follows said introducing.

8. The method of claim 7 wherein said finishing further comprises:
collecting said sheets in a single stack following said recto-printing steps, said stack having said sheets in a front-to-back order.

9. The method of claim 1 wherein said conveyor is an endless belt.

10. The method of claim 9 wherein said sheet supports are virtual divisions of said belt.

11. The method of claim 10 wherein said belt has machine-readable markings designating locations of said sheet supports.

12. The method of claim 1 wherein said printing steps each further comprise applying fuser oil and said one-side printable sheets are plastic films capable of transferring said fuser oil as a contaminant following the respective said printing step.

13. The method of claim 1 wherein said one-side printable sheets are adhesive labels having opposed adhesive and printable sides.

14. A printing method for use with a printer having a continuously-operated conveyor having a sequence of sheet supports, said method comprising the steps of:
placing each of a plurality of two-side printable sheets into respective sheet supports of a first segment of said sequence, said two-side printable sheets each having one side printable in an initial printing pass and another, opposite side printable in a subsequent printing pass;
excluding one or more one-pass printable sheets from said sequence of sheet supports, said one-pass printable sheets each having a printable recto side and a ventro side that is a vector of contamination to the printer, at least when printed sequential to said recto side, said excluding defining a skipped, second segment of said sequence, said second segment having one or more sheet supports;
verso-printing said two-side printable sheets in respective said sheet supports;
flipping over and replacing each of said plurality of two-side printable sheets in a respective said sheet support of said first segment;
then, recto-printing said two-side printable sheets in respective said sheet supports;
introducing said one-pass printable sheets into respective said sheet supports of said second segment in respective said sheet supports;
recto-printing said one-side printable sheets in respective said sheet supports;
then, finishing said sheets; and
during said finishing, maintaining said sheets in an order defined by said recto-printing steps.

15. The method of claim 14 wherein said printer is a digital electrophotographic printer, said one-pass printable sheets are plastic sheets, and said contamination is fuser oil.

16. The method of claim 14 wherein said one-pass printable sheets are adhesive labels and said contamination is adhesive.

17. The method of claim 14 wherein said second segment follows said first segment.

18. The method of claim 17 further comprising the steps of:
following said excluding, placing an additional one or more of the two-side printable sheets into respective sheet supports of a third segment of said conveyor, said third segment following said second segment;
verso-printing said additional two-side printable sheets in respective said sheet supports;
flipping over and returning said additional two-side printable sheets into respective said sheet supports of said third segment; and
recto-printing said additional two-side printable sheets in respective said sheet supports of said third segment;
wherein said verso-printing and flipping over of said additional two-side printable sheets precede said introducing and said recto-printing of said additional two-side printable sheets follows said introducing.

19. A printing system for use in printing sheets of media, said system comprising:
one or more print engines;
a conveyor having a sequence of sheet supports, said conveyor being continuously-operable to move said sequence of sheet supports in first and second passes past said one or more print engines;
two or more sheet supply units supplying respective sheets to said conveyor;
an inverter operatively disposed to flip said sheets and then return said sheets to said conveyor;
a output holder disposed to receive sheets from said conveyor; and
a control unit operatively connected to said one or more print engines, said conveyor, said sheet supply units, and said inverter, said control unit being programmed to operate said one or more print engines, said conveyor, and said sheet supply units to:
place each of a plurality of two-side printable sheets into respective sheet supports of a first segment of said sequence during said moving of said sequence in said first pass, said two-side printable sheets each having two opposed, sequentially-printable sides;
exclude one or more one-pass printable sheets from said sequence of sheet supports during said moving of said sequence in said first pass, said one-pass printable sheets each having a printable recto side and a ventro side that is a vector of contamination to the printer, at least when printed sequential to said recto side, said excluding defining a skipped, second segment of said sequence, said second segment having one or more sheet supports;
verso-print said two-side printable sheets during said moving of said sequence in said first pass;
flip over and replace each of said plurality of two-side printable sheets in a respective said sheet support of said first segment;
move said sequence of sheet supports in a second pass through said printer;
recto-print said two-side printable sheets during said moving of said sequence in said second pass;
introduce said one-pass printable sheets into respective said sheet supports of said second segment during said moving of said sequence in said second pass;
recto-print said one-side printable sheets during said moving of said sequence in said second pass; and
then, deliver said sheets to said output holder in an order defined by said recto-printing steps.

20. The system of claim 19 further comprising finishing equipment receiving said sheets from said output holder, said finishing equipment finishing said sheets and maintaining said order during said finishing.
